(19) United States
(12) Patent Application Publication
(10) Pub. No.: US 2015/0213581 A1
(43) Pub. Date: Jul. 30, 2015

(54) METHOD AND APPARATUS FOR IMAGE QUALITY ENHANCEMENT USING PHASE MODULATION OF HIGH FREQUENCY ELEMENTS

(71) Applicant: SAMSUNG ELECTRONICS CO., LTD., Suwon-si (KR)

(72) Inventor: Hyun-seung LEE, Seoul (KR)

(73) Assignee: SAMSUNG ELECTRONICS CO., LTD., Suwon-si (KR)

(21) Appl. No.: 14/608,862

(22) Filed: Jan. 29, 2015

(30) Foreign Application Priority Data
Jan. 29, 2014 (KR) 10-2014-0011253

(51) Int. Cl. G06T 5/00

(52) U.S. Cl. CPC G06T 5/001; G06T 5/009; G06T 2207/20172

(57) ABSTRACT

A method of enhancing quality of an image is provided, the method of enhancing quality including determining high frequency elements of the image, adding noise to and modulating a phase of the determined high frequency elements to generate modified high frequency elements, and restoring the image by using the modified high frequency elements.

### CROSS-REFERENCE TO RELATED APPLICATION

This application claims the benefit of Korean Patent Application No. 10-2014-0011253, filed on Jan. 29, 2014, in the Korean Intellectual Property Office, the disclosure of which is incorporated herein in its entirety by reference.

### BACKGROUND

1. Field

One or more exemplary embodiments relate to image quality improvement through phase modulation of high frequency elements.

2. Description of the Related Art

When an image is compressed or scaled, frequency elements of the image may be lost. When the frequency elements of the image, which are in a high frequency band, are lost, a fine texture of the image is damaged, and thus quality of the image may be degraded.

An image processing method of amplifying high frequency elements of the image which are in a weakened frequency band is used to improve the degraded quality of the image. However, when the high frequency elements of the image are amplified according to the above image processing method, overall sharpness of the image is improved but the high frequency elements of the image which have been lost cannot be restored. Thus, it is difficult to restore the fine texture of the image. In particular, the higher a quality degradation degree caused by high compression or high magnification is, the harder it is to improve the texture of the image through a method of the related art.

### SUMMARY

One or more exemplary embodiments provide a method of improving a texture of an image by modulating a phase of high frequency elements of the image and adding noise, and an apparatus therefor.

Additional aspects will be set forth in part in the description which follows and, in part, will be apparent from the description, or may be learned by practice of the presented exemplary embodiments.

According to an aspect of an exemplary embodiment, there is provided a method of enhancing quality of an image, the method including: determining high frequency elements of the image; adding noise to and modulating a phase of the determined high frequency elements to generate modified high frequency elements; and restoring the image by using the modified high frequency elements.

The determining of the high frequency elements may include frequency-converting the image into block units and determining coefficients of the high frequency elements.

The adding of the noise may include adding values of the noise to the coefficients of the high frequency elements included in the block units.

The modulating of the phase may include changing signs of the coefficients of the high frequency elements.

The modulating of the phase may further include increasing power of the high frequency elements included in the block units.

The restoring of the image may include: respectively adding weights to one of the block units to which the noise has been added, one of the block units in which the signs of the coefficients of the high frequency elements have been changed, and one of the block units in which the power of the high frequency elements has been increased, and compositing the added weights and the respective block units to generate composited block units; and restoring the composited block units to the image through frequency conversion.

The determining of the high frequency elements may include determining the high frequency elements in the image by using high-pass filters.

The adding of the noise may include generating a seed image by adding values of the noise to the determined high frequency elements.

The modulating of the phase may include modulating the phase by performing infinite impulse response (IIR) filtering on the seed image in a direction.

The restoring of the image may include compositing an image restored in a current frame and an image restored in a previous frame by performing temporal filtering, to thereby restore the image.

According to another aspect of an exemplary embodiment, there is provided an apparatus configured to enhance quality of an image, including: a high frequency determiner configured to determine high frequency elements of the image; a phase modulator configured to add noise to and modulate a phase of the determined high frequency elements to generate modified high frequency elements; and an image restorere configured to restore the image by using the modified high frequency elements.

The high frequency determiner may include a frequency converter configured to frequency-convert the image into block units and determine coefficients of the high frequency elements.

The phase modulator may include: a noise adder configured to add values of the noise to the coefficients of the high frequency elements included in the block units; a phase sign modulator configured to change signs of the coefficients of the high frequency elements included in the block units; and a de-blurrer configured to increase power of the high frequency elements included in the block units.

The image restorer may include: a compositer configured to respectively add weights to one of the block units to which the noise has been added, one of the block units in which the signs of the coefficients have been changed, and one of the block units in which the power of the high frequency elements has been increased, and to composite the weights and the block unit to which the noise has been added, the block unit in which the signs of the coefficients have been changed, and the block unit in which the power of the high frequency elements has been increased to generate composited block units; and a frequency inverter configured to restore the image by frequency-inverting the composited block units.

The high frequency determination unit may include high-pass filters configured to filter the high frequency elements in the image.

The phase modulator may include: a seed image generator configured to add values of the noise to the determined high frequency elements and generate a seed image based on the added values; and infinite impulse response (IIR) filters configured to modulate a phase of the seed image by performing IIR filtering on the generated seed image.

The image restorer may include a compositer configured to composite an image restored in a current frame and an image restored in a previous frame by performing temporal filtering, to thereby restore the image.

According to another aspect of an exemplary embodiment, there is provided a non-transitory computer readable recording medium having embodied thereon a computer program for executing the method according to an aspect of an exemplary embodiment.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of an image quality enhancement device according to an exemplary embodiment;

FIG. 2 is a flowchart of a method of enhancing the quality of an image according to an exemplary embodiment;

FIG. 3 is a flowchart of an image quality enhancement device according to another exemplary embodiment;

FIG. 4 shows a frequency-converted block unit, according to an exemplary embodiment;

FIG. 5 shows modified phase signs according to an exemplary embodiment;

FIG. 6 is a flowchart of a method of enhancing the quality of an image through phase modulation of a high frequency in a frequency domain, according to an exemplary embodiment;

FIG. 7 is a block diagram of an image quality enhancement device according to another exemplary embodiment;

FIG. 8 is a block diagram of an infinite impulse response (IIR) filter according to an exemplary embodiment;

FIGS. 9A, 9B, 9C and 9D illustrate scanning directions of IIR filters, according to an exemplary embodiment;

FIG. 10 shows IIR filtering according to an exemplary embodiment;

FIG. 11 is a flowchart of a method of enhancing the quality of an image through phase modulation of a high frequency in a spatial domain, according to an exemplary embodiment; and

FIG. 12 is a block diagram of an image quality enhancement device according to another exemplary embodiment.

### DETAILED DESCRIPTION

Hereinafter, certain exemplary embodiments will be described in detail. According to an exemplary embodiment, the terms “ . . . unit”, “ . . . module”, etc., are units for processing at least one function or operation and may be implemented as hardware, software, or a combination of hardware and software.

The term “an exemplary embodiment” or “one or more exemplary embodiments” may include specific features, structures, characteristics, etc., described with reference to an exemplary embodiment included on at least one exemplary embodiment. Therefore, the expressions such as “in an exemplary embodiment” or “in one or more exemplary embodiments” used throughout the specification may not indicate the same exemplary embodiment.

Hereinafter, the exemplary embodiments will be described in detail by explaining certain exemplary embodiments thereof with reference to the attached drawings.

FIG. 1 is a block diagram of an image quality enhancement device 100 according to an exemplary embodiment.

Referring to FIG. 1, the image quality enhancement device 100 includes a high frequency determination unit 110 (e.g., “high frequency determiner”), a phase modulation unit 120 (e.g., “phase modulator”), and an image restoration unit 130 (e.g., “image restorer”). In the image quality enhancement device 100, only components related to the present exemplary embodiment are included. Therefore, one of ordinary skill in the art would have been able to understand that other widely-used components other than the above components of FIG. 1 may be further included in the image quality enhancement device 100.

The image quality enhancement device 100 has a central processing unit (CPU) or a graphic processor and may generally control operations of the high frequency determination unit 110, the phase modulation unit 120, and the image restoration unit 130. Also, a CPU may be included in each of the high frequency determination unit 110, the phase modulation unit 120, and the image restoration unit 130 and may operate in substantially the same fashion as each other.

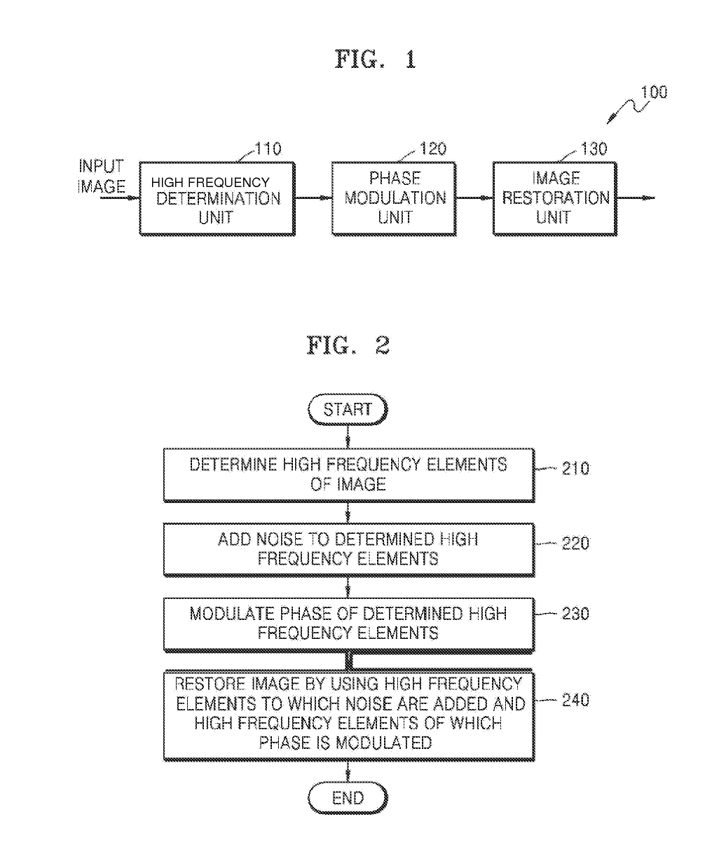

Hereinafter, detailed operations of the image quality enhancement device 100 will be described with reference to FIG. 2.

FIG. 2 is a flowchart of a method of enhancing the quality of an image according to an exemplary embodiment.

In operation S210, the high frequency determination unit 110 may determine high frequency elements of an image. For example, the high frequency determination unit 110 may convert a frequency or may use a high-pass filter (HPF) in order to determine (e.g., filter) the high frequency elements of the image.

In operation S220, the phase modulation unit 120 may add noise to the determined high frequency elements and may modulate a phase of the determined high frequency elements. Also, the phase modulation unit 120 may amplify the determined high frequency elements based on a quality degradation degree. The noise added to the high frequency elements may be variables that are randomly generated. Also, the phase of the high frequency elements of the image may be modulated in a frequency domain or a spatial domain.

In operation S230, the image restoration unit 130 may restore the image by using the high frequency elements to which the noise has been added and the high frequency element of which the phase has been modulated. For example, the image restoration unit 130 may enhance quality of the image by compositing an original image and the high frequency elements to which the noise has been added and of which the phase has been modulated. In this case, the image restoration unit 130 may add a predetermined weight to each high frequency element in consideration of the quality degradation degree which may change according to compression or enlargement of the image and may composite the high frequency elements and the original image.

The method of enhancing the quality of the image may be performed in the frequency domain and/or the spatial domain. That is, the determination of the high frequency elements, the addition of noise to the high frequency elements, and the phase modulation may be performed in the frequency domain and/or the spatial domain.

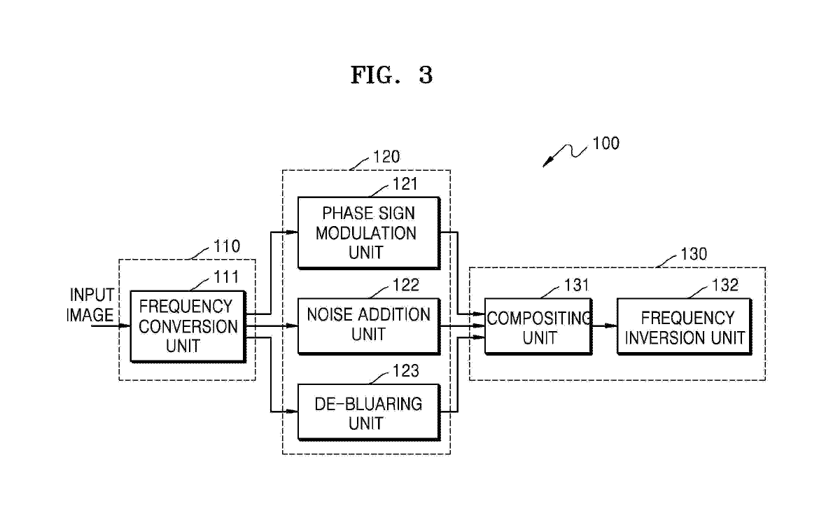

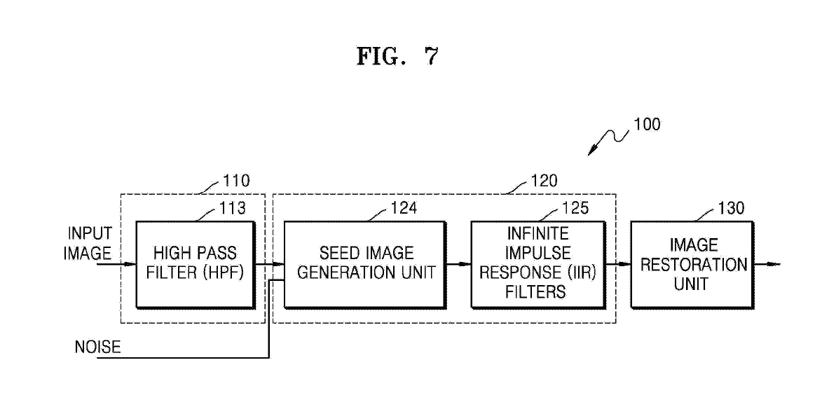

A method of enhancing the quality of the image in the frequency domain will be described with reference to FIGS. 3 to 6, and a method of enhancing the quality of the image in the spatial domain will be described with reference to FIGS. 7 to 11. A method of enhancing the quality of the image in the frequency domain and the spatial domain will be described with reference to FIG. 12.

FIG. 3 is a flowchart of an image quality enhancement device according to another exemplary embodiment.

Referring to FIG. 3, the high frequency determination unit 110 includes a frequency conversion unit 111 (e.g., frequency converter), and the phase modulation unit 120 includes a phase sign modulation unit 121 (e.g., phase sign modulator), a noise addition unit 122 (e.g., noise adder), and a de-blurring unit 123 (e.g., de-blurrer). The image restoration unit 130 may include a compositing unit 131 (e.g., compositer) and a frequency inversion unit 132 (e.g., frequency inverter).

The frequency conversion unit 111 generates a block unit after the image is frequency-converted and then may determine coefficients of the high frequency elements in the block unit. For example, the frequency conversion unit 111 may convert a block unit which has N×N pixels into a block unit which has N×N discrete cosine transform (DCT) coefficients through a DCT process. The conversion process in the frequency conversion unit 111 may be performed according to the following equation 1:

Y_DCT=DCT(Y) Equation (1)

where Y indicates the N×N pixels of the block unit of the image, and DCT( ) indicates DCT. Y_DCT indicates the N×N DCT coefficients.

The frequency conversion unit 111 may determine the high frequency elements based on locations of the coefficients in the block unit which is frequency-converted.

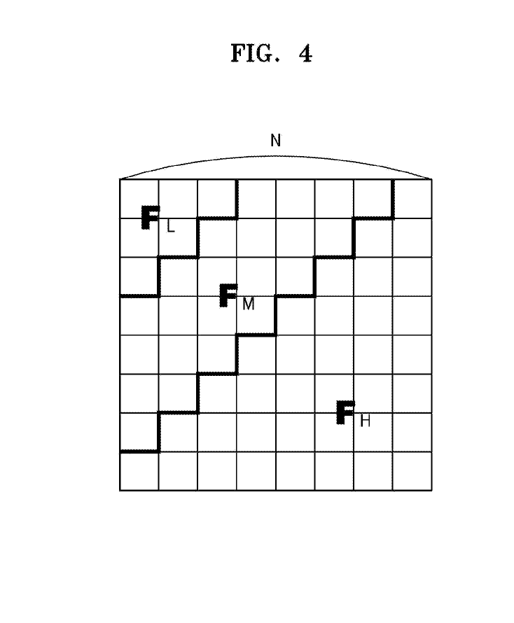

For example, FIG. 4 shows an example of the frequency-converted block unit, according to an exemplary embodiment.

Referring to FIG. 4, the block unit, which is converted through the DCT process, has N×N coefficients. Also, the coefficients included in the frequency-converted block unit may be placed in a high frequency element (F_{H}) area, an intermediate frequency element (F_{M}) area, and a low frequency element (F_{L}) area according to locations of the coefficients. A range of the high frequency elements is not limited to the area of FIG. 4 and may be arbitrarily selected.

Therefore, the frequency conversion unit 111 may determine coefficients of the high frequency elements through frequency conversion.

Referring back to FIG. 3, the phase sign modulation unit 121 may change signs of the coefficients of the high frequency elements included in the frequency-converted block unit. That is, phase information is indicated as the signs of the coefficients of the high frequency elements, and the phase sign modulation unit 121 may change properties of signals by changing the signs of the coefficients while power of the coefficients are maintained. In particular, when a phase of the high frequency elements is modulated, properties of the high frequency of the image vary, and thus, the quality of the image is enhanced. On the contrary, when a phase of the low frequency elements is modulated, the image may be distorted and may not be clearly displayed. Therefore, the phase sign modulation unit 121 may modulate a phase of frequency elements placed in the F_{H} area.

A method which changes the signs of the coefficients of the high frequency elements included in the frequency-converted block unit and is performed by the phase sign modulation unit 121 will be described with reference to Equations 2 and 3.

The phase sign modulation unit 121 may separate the DCT coefficients calculated according to Equation 1 into signs and power of the coefficients according to the following Equation 2:

Y_DCT(i,j)=SIGN(i,j)*|Y_DCT(i,j)| Equation (2)

where Y_DCT indicates DCT coefficients, and SIGN indicates signs of the DCT coefficients. |Y_DCT| indicates the power of the DCT coefficients. Also, i and j may be integers that are less than or equal to N and may indicate locations of the DCT coefficients in a block unit.

Furthermore, the phase sign modulation unit 121 may modulate the phase of the high frequency elements by determining modulated phase signs (SIGN_MODUL) after the signs (SIGN) of the DCT coefficients are multiplied by coefficients of SIGN_MODUL or by using the coefficients of SIGN_MODUL instead of the signs (SIGN) of the DCT coefficients. The modulated phase signs (SIGN_MODUL) may be selected as shown in FIG. 5.

That is, the phase sign modulation unit 121 may change coefficients to allow respective coefficients to have different phases from neighboring coefficients so that differences in phases of nearby frequencies may be as large as possible.

Operations of the phase sign modulation unit 121 may be performed according to the following Equation 3:

$$\{ \begin{matrix}Y\_DCT \_MODUL ( i , j ) = SIGN\_MODUL ( i , j ) * & == 1 \\ \vert Y\_DCT ( i , j ) \vert , if F\_H \_MAP ( i , j ) & \\ 0 , & else\end{matrix} \qquad Equation 3$$

Where Y_DCT_MODUL indicates DCT coefficients having modulated phases, and SIGN_MODUL indicates modulated phase signs. |Y_DCT| indicates the power of coefficients, and F_H_MAP is a function which returns 1 when coefficients having modulated phases are placed in the high frequency area (F_{H}).

The phase sign modulation unit 121 multiplies the power of the coefficients (|Y_DCT|) and modulated phase signs (SIGN_MODUL) on a location of each coefficient (i and j) and may acquire DCT coefficients (Y_DCT_MODUL) of the high frequency elements of the image which have modulated phases. Thus, the acquired DCT coefficients are composited with the image, and the quality of the image may be enhanced.

The noise addition unit 122 may add predetermined noise to the coefficients of the high frequency elements included in the frequency-converted block unit. In general, when the high frequency elements are lost while the image is compressed or enlarged, or when the high frequency elements have low power, the quality of the image may be poor. Therefore, the noise addition unit 122 may intentionally add noise to the high frequency elements and may enhance the quality of the image. The noise may be random elements, and the random elements (Y_RND) may be embodied by using sources which have an average of 0 and various properties.

Operations of the noise addition unit 122 may be performed according to the following Equation 4:

$$\{ \begin{matrix}Y\_DCT \_NOISE ( i , j ) = Y\_RND ( i , j ) , & == 1 \\ if F\_H \_MAP ( i , j ) & \\ 0 , & else\end{matrix} \qquad Equation 4$$

where Y_DCT_NOISE indicates the DCT coefficients to which the noise has been added, Y_RND indicates values of the noise, and F_H_MAP is a function which returns 1 when coefficients having a modulated phase are placed in the high frequency (F_{H}) area of FIG. 4.

Therefore, the noise addition unit 122 may acquire the DCT coefficients (Y_DCT_NOISE) which have values of noise to be added to the high frequency elements and may composite the acquired DCT coefficients and the image so that the quality of the image may be enhanced.

The de-blurring unit 123 may increase the power of the high frequency elements included in the frequency-converted block unit.

That is, the de-blurring unit 123 may increase the power of coefficients by multiplying a predetermined weight A to the DCT coefficients (Y_DCT). The weight A may be determined by information stored in a register or may be calculated according to degradation information included in image streams.

Operations of the de-blurring unit 123 may be performed according to the following Equation 5:

Y_DCT_DEBLUR(i,j)=Y_DCT(i,j)*A(i,j) Equation 5

where Y_DCT indicates DCT coefficients, A indicates a weight of each coefficient, and Y_DCT_DEBLUR indicates coefficients having increased power. Also, i and j may be integers that are less than or equal to N and indicate locations of the coefficients in the block units.

The compositing unit 131 may add predetermined weights to the block unit to which the noise has been added, the block unit in which signs of the coefficients have been changed, and the block unit in which the power of the coefficients has been increased and may composite the same.

That is, the compositing unit 131 may composite the coefficients included in the block units generated by the phase sign modulation unit 121, the noise addition unit 122, and the de-blurring unit 123 by using weight sums according to the following Equation 6:

Y_DCT_MIX=Y_DCT_DEBLUR+w1*Y_DCT_NOISE+w2*Y_DCT_MODUL Equation 6

where w1 and w2 are weights for the coefficients included in the block unit to which the noise has been added and for the coefficients included in the block unit in which phase modulation has been performed. Y_DCT_MIX are coefficients of the block units in which elements generated by the phase sign modulation unit 121, the noise addition unit 122, and the de-blurring unit 123 are composited.

Additionally, the phase modulation unit 120 may have the weight sums and frequency conversion coefficients (Y_DCT) which are provided before the phase modulation or noise addition is performed.

In this case, final frequency conversion coefficients (Y_DCT_FINAL) may be calculated according to the following Equation 7:

Y_DCT_FINAL=w3*Y_DCT_MIX+(1−w3)*Y_DCT [Equation 7]

where Y_DCT_FINAL corresponds to final frequency conversion coefficients of the block units, and Y_DCT corresponds to conversion coefficients in which only DCT is performed for the image. Y_DCT_MIX corresponds to coefficients of the block units in which elements generated by the phase sign modulation unit 121, the noise addition unit 122, and the de-blurring unit 123 are composited. Also, w3 is a weight having a range between 0 and 1.

The frequency inversion unit 132 may generate an image (Y_Enhance_F) of which high frequency elements are modulated by performing conversion according to the following Equation 8:

Y_Enhance_{—}F=IDCT(Y_DCT_FINAL) [Equation 8]

where IDCT( ) indicates an inverse discrete cosine transform, and Y_DCT_FINAL indicates the final frequency conversion coefficients of the block units with regard to Equation 7. Y_Enhance_F indicates an image of which high frequency elements are modulated in a frequency domain.

Therefore, the image quality enhancement device 100 may generate an image (Y_Enhance_F) in which noise has been added to the high frequency elements in the frequency domain and a phase of the high frequency elements has been modulated.

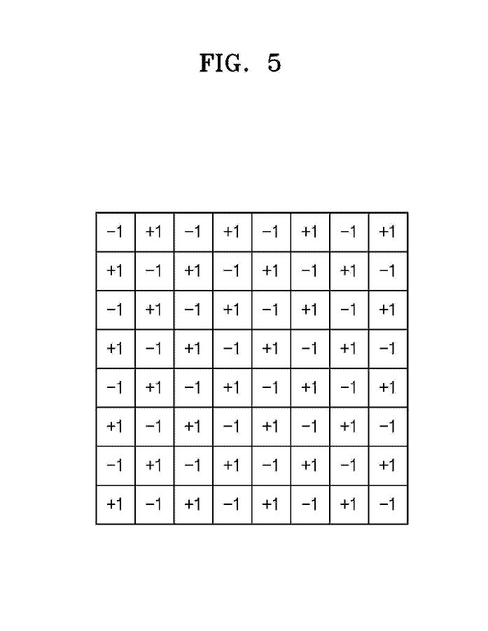

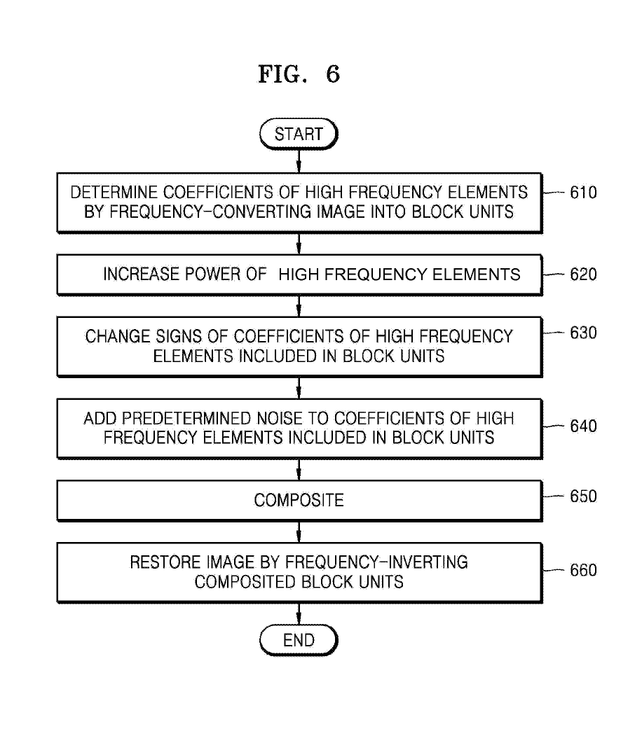

FIG. 6 is a flowchart of a method of enhancing the quality of an image through phase modulation of a high frequency in a frequency domain, according to an exemplary embodiment.

Referring to FIG. 6, the method of enhancing the quality of the image through the phase modulation of the high frequency in the frequency domain includes processes which are time-serially performed by the image quality enhancement device 100 as shown in FIGS. 1 to 3. Therefore, the descriptions of the image quality enhancement device 100 which have been provided with reference to FIGS. 1 to 3 may be applied to the method of FIG. 6.

Referring to FIG. 6, the frequency conversion unit 111 may generate block units by frequency-converting an image and may determine coefficients of high frequency elements in the block units. For example, the frequency conversion unit 111 may convert block units having N×N pixels into block units having N×N DCT coefficients through a DCT process. Also, the frequency conversion unit 111 may determine the high frequency elements based on locations of the coefficients in the frequency-converted block units, in operation S610.

In operation S620, the de-blurring unit 123 may increase power of the high frequency elements included in the frequency-converted block units. That is, the de-blurring unit 123 may increase the power of the high frequency elements by multiplying a predetermined weight A by DCT coefficients (Y_DCT) converted into block units. The weight A may be determined by a predetermined register or may be calculated according to degradation information included in image streams.

In operation S630, the phase sign modulation unit 121 may change signs of the coefficients of the high frequency elements included in the frequency-converted block units. That is, phase information of the coefficients of the high frequency elements is indicated as signs, and the phase sign modulation unit 121 may change properties of signals by changing the signs of the coefficients while maintaining the power of the coefficients.

In operation S640, the noise addition unit 122 may add predetermined noise to the coefficients of the high frequency elements included in the frequency-converted block units. Therefore, the noise addition unit 122 may intentionally add values of the noise to the high frequency elements and may enhance the quality of the image. The noise may be random elements, and the random elements (Y_RND) may be embodied by using sources which have an average of 0 and various properties.

Operations S620 to S640 are not required to be performed in the order shown in FIG. 6, and alternatively, the order of operations S620 to S640 may change, or at least two of the operations S620 to S640 may be performed in parallel. Alternatively, any one of operations S620 to S640 may be omitted.

In operation S650, the compositing unit 131 may respectively add predetermined weights to the block unit to which the noise has been added, the block unit in which the signs of the coefficients have been changed, and the block unit in which the power of the coefficients has been increased and may composite the block units.

Also, the compositing unit 131 may additionally composite the composited block units and the block unit in which only frequency conversion is performed, by adding a weight thereto. In this case, weight sums may be calculated.

In operation S660, the frequency inversion unit 132 may restore the image by frequency-inverting the block units composited by the compositing unit 131. That is, the image having enhanced quality may be acquired by restoring the image in which the high frequency elements are modulated in the frequency domain.

A method of enhancing the quality of the image in the spatial domain will be described with reference to FIGS. 7 to 11.

FIG. 7 is a block diagram of an image quality enhancement device 100 according to another exemplary embodiment.

Referring to FIG. 7, the frequency determination unit 110 includes a high-pass filter (HPF) 113, and the phase modulation unit 120 may include a seed image generation unit 124 (e.g., seed image generator) and infinite impulse response (IIR) filters 125.

The HPF 113 may extract only high frequency elements from an image. The HPF 113 may variously adjust frequency response properties and may be embodied as one or more filters. For example, the HPF 113 may be a Laplacian filter.

The seed image generation unit 124 may generate a seed image by adding high frequency elements passing the HPF 113 and predetermined noise. Since there is a limit to restoring elements in a texture domain by using the high frequency which is directly extracted from the image, elements having random values may be added to the high frequency elements passing the HPF 113. The random values are values regarding brightness of the image and may be embodied by using sources which have an average of 0 and various properties.

A process performed by the seed image generation unit 124 may be performed according to the following Equation 9:

Y_SEED=Y_HF+Y_RND′ Equation 9

where Y_SEED is the generated seed image, Y_HF is an image passing the HPF 113, and Y_RND′ indicates the random values.

The IIR filter 125 may change a phase and power of the image by performing IIR filtering for the generated seed image in at least one direction. That is, when IIR filtering is performed in a single direction by using the IIR filters 125 in order to amplify the power of the seed image, pixels that are previously processed affect brightness values of locations corresponding to current pixels, and thus, the phase of the image is modulated. Therefore, phase modulation effects may vary according to the number of the IIR filters 125 and coefficients thereof.

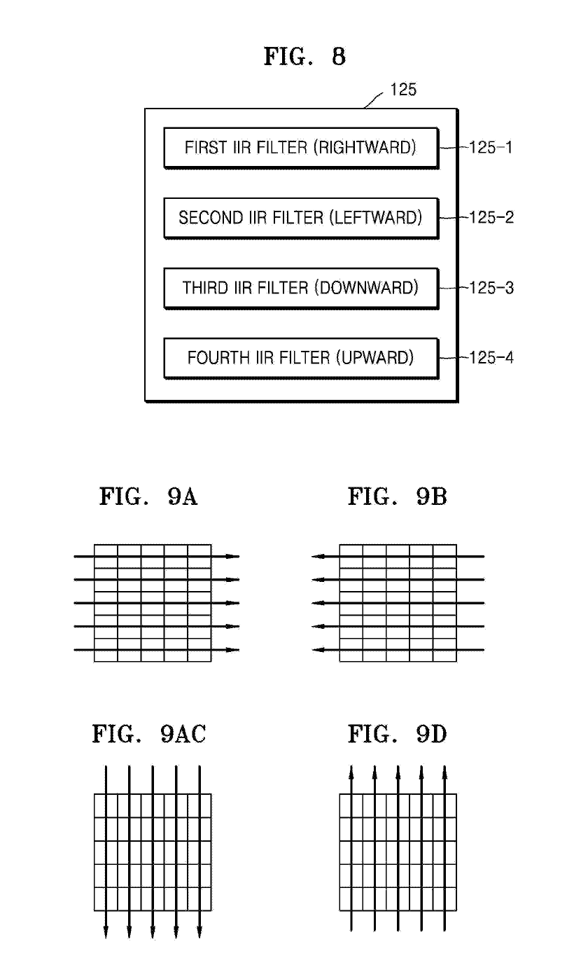

FIG. 8 is a block diagram of the IIR filters 125 according to an exemplary embodiment, and FIGS. 9A, 9B, 9C and 9D are scanning directions of the IIR filters 125 according to an exemplary embodiment.

Referring to FIG. 8, the IIR filters 125 may include a first IIR filter 125-1, a second IIR filter 125-2, a third IIR filter 125-3, and a fourth IIR filter 125-4, respective scanning directions of which are a rightward direction, a leftward direction, a downward direction, and an upward direction.

The scanning directions of the first IIR filter 125-1, the second IIR filter 125-2, the third IIR filter 125-3, and the fourth IIR filter 125-4 correspond to FIGS. 9A to 9D, respectively. Therefore, the IIR filters 125 include the first IIR filter 125-1, the second IIR filter 125-2, the third IIR filter 125-3, and the fourth IIR filter 125-4 having four different scanning directions, which may achieve increased phase modulation effects. In the present exemplary embodiment, the IIR filters 125 include sub-filters having four scanning directions, but are not limited thereto, and more or less than four sub-filters and four scanning directions may be implemented in accordance with other exemplary embodiments.

Hereinafter, an example of performing IIR filtering by using the IIR filters 125 will be described.

FIG. 10 shows IIR filtering according to an exemplary embodiment.

FIG. 10 shows IIR filtering performed by the first IIR filter 125-1 having the rightward scanning direction.

Referring to FIG. 10, as indicated by the following Equation 10, brightness (Y_S) of pixels on which the IIR filter is performing a filtering operation may be calculated by using brightness values (Y_CUR) of pixels in a current location and brightness values (Y_S_PREV) of pixels in locations where the IIR filtering has been previously performed:

Y_{—}S_LR=a*Y_{—}S_LR_PREV+b*Y_SEED_CUR Equation 10

where Y_S_LR indicates a brightness value of a pixel in which the IIR filtering is performed in a rightward direction, Y_S_LR_PREV indicates a brightness value of a pixel in which the IIR filtering has been previously performed in a leftward direction by using the first IIR filter 125-1, Y_SEED_CUR indicates a brightness value of a pixel in which the (IIR) filtering is currently performed, a indicates a filter coefficient value with regard to the brightness value of the pixel in which the (IIR) filtering has been previously performed, and b indicates a filter coefficient value with regard to the brightness value of the pixel in which the (IIR) filtering is currently performed.

When IIR filtering is performed by the first to fourth IIR filters 125-1 to 125-4 with regard to the seed image based on Equation 10, seed images having differently modulated phases may be acquired. In this case, an image (Y_Enhance_S) in which a phase and power of high frequency elements of the image are modulated in a spatial domain may be output by adding weights according to the following Equation 11 to the seed images having differently modulated phases:

Y_Enhance_{—}S=a1*Y_{—}S_LR+a2*Y_{—}S_RL+a3*Y_{—}S_TB+a4*Y_{—}S_BT [Equation 11]

where Y_Enhance_S indicates the image in which the phase and power of high frequency elements of the image are modulated in the spatial domain, Y_S_LR, Y_S_RL, Y_S_TB, and Y_S_BT respectively indicate images in which phases and power are modulated through the IIR filtering performed on the seed images in the rightward direction, the leftward direction, the downward direction, and the upward direction, and a1, a2, a3, and a4 respectively indicate weights for the images.

The image restoration unit 130 may restore an output image by using the image in which the phase and power of high frequency elements of the image are modulated in the spatial domain. That is, the image restoration unit 130 may restore an image having enhanced quality by respectively adding predetermined weights to the image in which the phases and power are modulated through the IIR filtering and an input image from which high frequency elements are not separated.

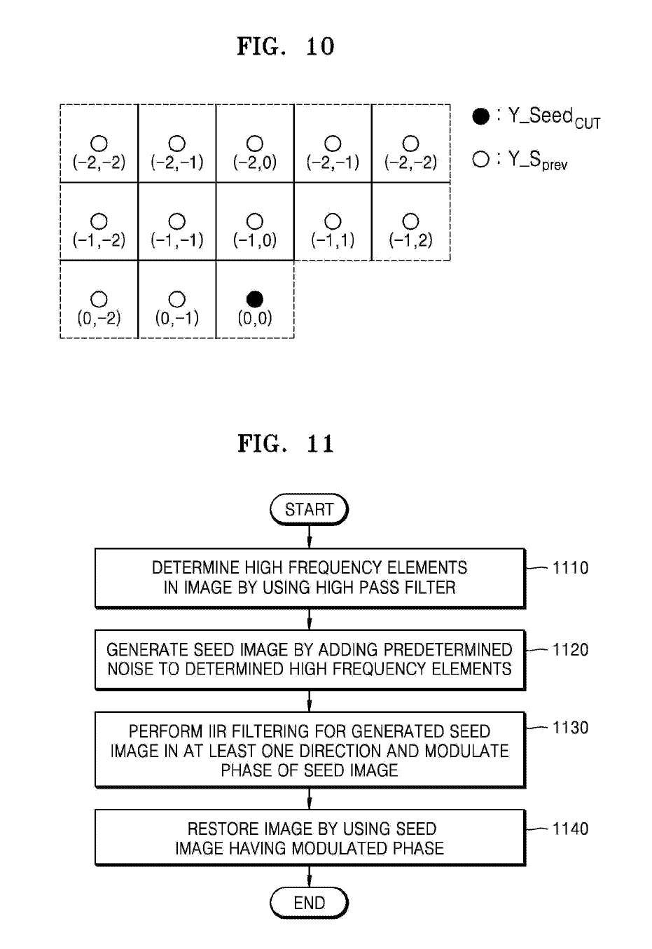

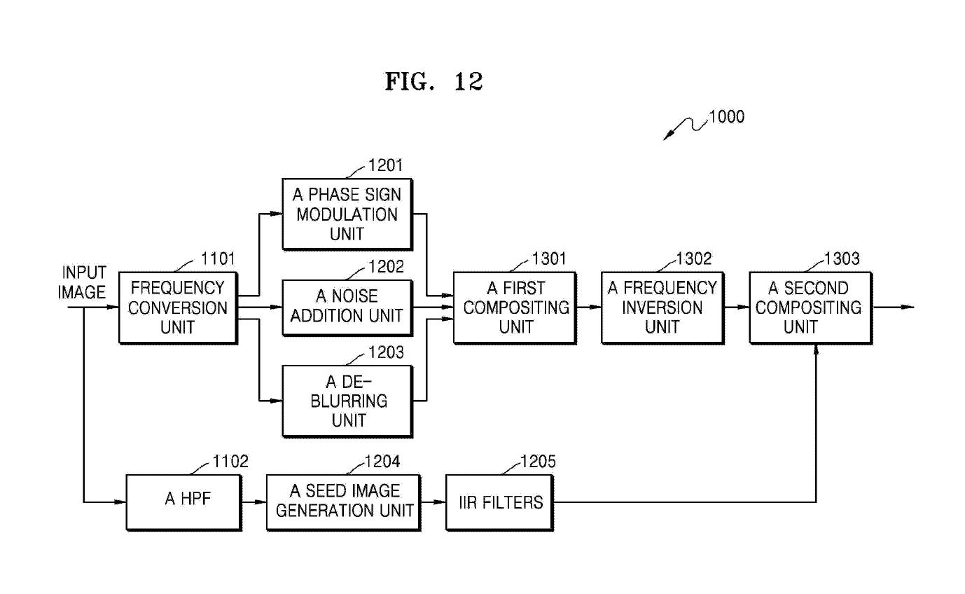

FIG. 11 is a flowchart of a method of enhancing the quality of an image through phase modulation of a high frequency in a spatial domain, according to an exemplary embodiment.

Referring to FIG. 11, the method of enhancing the quality of the image through the phase modulation of the high frequency in the spatial domain includes processes that are time-serially performed by the image quality enhancement device 100 as shown in FIGS. 1 and 7. Therefore, the descriptions regarding the image quality enhancement device 100 shown in FIGS. 1 and 7 may be applied to the method of FIG. 11.

Referring to FIG. 11, in operation S1110, the HPF 113 may extract high frequency elements from the image.

In operation S1120, the seed image generation unit 124 may add predetermined noise to the high frequency elements passing the HPF 113 and may generate a seed image. Values of the noise are values related to brightness of the image and may be embodied by using sources which have an average of 0.

In operation S1130, the IIR filters 125 perform IIR filtering in at least one direction with regard to the generated seed image and may change a phase and power of the image. For example, when the IIR filtering is performed with regard to the generated seed image in the directions of the first to fourth IIR filters 125-1 to 125-4, seed images which have differently modulated phases may be acquired.

In operation S1140, the image restoration unit 130 may restore the image by using the seed images which have the differently modulated phases. That is, the image restoration unit 130 may restore an image having improved quality by adding predetermined weights to the seed images in which the phase and power are modulated through the IIR filtering and the image from which the high frequency elements are not separated.

Hereinafter, a method of enhancing the quality of the image in the frequency domain and the spatial domain will be described with reference to FIG. 12.

FIG. 12 is a block diagram of an image quality enhancement device 1000 according to another exemplary embodiment.

Referring to FIG. 12, the image quality enhancement device 1000 may include a frequency conversion unit 1101, a high-pass filter (HPF) 1102, a phase sign modulation unit 1201 (e.g., phase sign modulator), a noise addition unit 1202 (noise adder), a de-blurring unit 1203 (e.g., deblurrer), a seed image generation unit 1204 (e.g., seed image generator), IIR filters 1205, a first compositing unit 1301 (e.g., first compositer), a frequency inversion unit 1302 (e.g., frequency inverter), and a second compositing unit 1303 (e.g., second compositer).

The frequency conversion unit 1101, the phase sign modulation unit 1201, the noise addition unit 1202, the de-blurring unit 1203, the first compositing unit 1301, and the frequency inversion unit 1302 respectively correspond to the frequency conversion unit 111, the phase sign modulation unit 121, the noise addition unit 122, the de-blurring unit 123, the first compositing unit 131, and the frequency inversion unit 132 of FIG. 3, and thus, descriptions thereof will be omitted.

Also, the HPF 1102, the seed image generation unit 1204, and the IIR filters 1205 respectively correspond to the HPF 112, the seed image generation unit 124, and the IIR filters 125 of FIG. 7, and thus, descriptions thereof will be omitted.

The second compositing unit 1303 will be described in detail with reference to FIG. 12.

The frequency inversion unit 1302 may output the image (Y_Enhance_F) in which the high frequency elements are modulated in the frequency domain according to Equation 8.

Also, the IIR filters 1205 may output an image (Y_Enhance_S) in which a phase and power of the high frequency elements are modulated in the spatial domain, according to Equation 11.

The second compositing unit 1303 may respectively add predetermined weights to the images (Y_Enhance_F, Y_Enhance_S) processed in the frequency and spatial domains and may composite the images. Operations of the second compositing unit 1303 may be performed according to the following Equation 12:

Y_Final=a*Y_Enhance_{—}F+b*Y_Enhance_{—}S+Y_org Equation 12

where Y_Final indicates images in which an input image and the images processed in the frequency and spatial domains are composited, Y_Enhance_F indicates the image processed in the frequency domain, Y_Enhance_S indicates the image processed in the spatial domain, and a and b are weights for the images processed in the frequency and spatial domains.

Therefore, the image quality enhancement device 1000 of FIG. 12 may effectively enhance quality of the image by modulating the phase of the high frequency elements of the image in the frequency and spatial domains.

The second compositing unit 1303 may combine an image which is finally composited with a result of a previous frame through temporal filtering. Thus, the image quality enhancement device 100 according to another exemplary embodiment may output a moving image having improved quality without flickering. The temporal filtering is not limited to any particular temporal filtering and may be implemented according to various types of temporal filtering operations. For example, the temporal filtering may be a method of compensating movement by using motion vectors.

An operation of performing the temporal filtering by the second compositing unit 1303 may be performed according to the following Equation 13:

Y=a*MC(Y_Final(n−1))+(1×a)*Y_Final(n) Equation 13

where Y indicates an image in which the temporal filtering is performed, Y_Final indicates an image in which the images processed in the frequency and spatial domains and the input image are composited, MC( ) indicates the temporal filtering, and a is a weight of between 0 and 1.

According to the method of enhancing the quality of the image according to one or more of the exemplary embodiments, an image which has degraded quality due to high compression or high magnification may be provided with enhanced quality by adding noise to high frequency elements of the image or performing phase modulation in a frequency domain or a spatial domain.

The exemplary embodiments have been particularly shown and described with reference to certain exemplary embodiments thereof. However, the exemplary embodiments should not be construed as being limited to the certain exemplary embodiments described herein.

It will be understood by one of ordinary skill in the art that the attached block diagrams conceptually illustrate circuits for embodying the principles of certain exemplary embodiments. Similarly, one of ordinary skill in the art will understand that arbitrary flowcharts, state transition diagrams, pseudo-codes, or the like may be materially expressed by a computer readable recording medium and represent various processes executable on a computer or a processor whether or not the computer or the processor is explicitly illustrated. Therefore, the exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), etc.

Functions of various components shown in the attached drawings may be associated with software and may be provided by hardware which can execute the software as well as exclusively by software. When functions are provided by a processor, those functions may be provided by a single exclusive processor, a single shared processor, or multiple processors, some of which may be shared. Also, the term “processor” or “controller” should not be construed as exclusively referring to hardware capable of executing software and may include digital signal processor (DSP) hardware, a ROM for storing software, a random access memory (RAM), and a non-volatile storage device.

In the detailed description, components that are described as media for performing particular functions may encompass arbitrary methods of performing the functions. The above components may include combinations of circuit components performing particular functions, or software (e.g., firmware, micro-codes, etc.) which is combined with circuits to perform particular functions.

As used herein, the term “and/or” includes any and all combinations of one or more of the associated listed items. As another example, the expression “at least one of A, B, and C” may include a first option A, a second option B, a third option C, a combination of A and B, a combination of B and C, or all combinations of A, B, and C. Even if more than three items are listed, one of ordinary skill in the art may be able to broadly understand such an expression.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the exemplary embodiments as defined by the following claims.

What is claimed is:

1. A method of enhancing quality of an image, the method comprising:
determining high frequency elements of the image;
adding noise to and modulating a phase of the determined high frequency elements to generate modified high frequency elements; and
restoring the image by using the modified high frequency elements.

2. The method of claim 1, wherein the determining of the high frequency elements comprises frequency-converting the image into block units and determining coefficients of the high frequency elements.

3. The method of claim 2, wherein the adding of the noise comprises adding values of the noise to the coefficients of the high frequency elements comprised in the block units.

4. The method of claim 3, wherein the modulating of the phase comprises changing signs of the coefficients of the high frequency elements.

5. The method of claim 4, wherein the modulating of the phase further comprises increasing power of the high frequency elements comprised in the block units.

6. The method of claim 5, wherein the restoring of the image comprises:
respectively adding weights to one of the block units to which the noise has been added, one of the block units in which the signs of the coefficients of the high frequency elements have been changed, and one of the block units in which the power of the high frequency elements has been increased, and compositing the added weights and the respective block units to generate composited block units; and
restoring the composited block units to the image through frequency conversion.

7. The method of claim 1, wherein the determining of the high frequency elements comprises determining the high frequency elements in the image by using high-pass filters.

8. The method of claim 7, wherein the adding of the noise comprises generating a seed image by adding values of the noise to the determined high frequency elements.

9. The method of claim 8, wherein the modulating of the phase comprises modulating the phase by performing infinite impulse response (IIR) filtering on the seed image in a direction.

10. The method of claim 1, wherein the restoring of the image comprises compositing an image restored in a current frame and an image restored in a previous frame by performing temporal filtering, to thereby restore the image.

11. An apparatus configured to enhance quality of an image, the apparatus comprising:
a high frequency determiner configured to determine high frequency elements of the image;
a phase modulator configured to add noise to and modulate a phase of the determined high frequency elements to generate modified high frequency elements; and
an image restorer configured to restore the image by using the modified high frequency elements.

12. The apparatus of claim 11, wherein the high frequency determiner comprises a frequency converter configured to frequency-convert the image into block units and determine coefficients of the high frequency elements.

13. The apparatus of claim 12, wherein the phase modulator comprises:
a noise adder configured to add values of the noise to the coefficients of the high frequency elements comprised in the block units;
a phase sign modulator configured to change signs of the coefficients of the high frequency elements comprised in the block units; and
a de-blurrer configured to increase power of the high frequency elements comprised in the block units.

14. The apparatus of claim 13, wherein the image restorer comprises:
a compositer configured to respectively add weights to one of the block units to which the noise has been added, one of the block units in which the signs of the coefficients have been changed, and one of the block units in which the power of the high frequency elements has been increased, and to composite the weights and the block unit to which the noise has been added, the block unit in which the signs of the coefficients have been changed, and the block unit in which the power of the high frequency elements has been increased to generate composited block units; and
a frequency inverter configured to restore the image by frequency-inverting the composited block units.

15. The apparatus of claim 11, wherein the phase modulator comprises:
a seed image generator configured to add values of the noise to the determined high frequency elements and generate a seed image based on the added values; and
infinite impulse response (IIR) filters configured to modulate a phase of the seed image by performing IIR filtering on the generated seed image.

16. The apparatus of claim 11, wherein the image restorer comprises a compositer configured to composite an image restored in a current frame and an image restored in a previous frame by performing temporal filtering, to thereby restore the image.

17. A non-transitory computer readable medium having embodied thereon a computer program which, when executed, causes a computer to perform the method of claim 1.

18. An image processing apparatus, comprising:
an element determiner configured to determine elements of an image which have a frequency above a predetermined threshold;
a noise adder configured to add noise to the determined elements to generate modified elements; and
an image restorer configured to enhance a quality of the image according to the modified elements,
wherein the noise comprises randomly selected values.

19. The image processing apparatus of claim 18, further comprising a phase modulator configured to modulate a phase of the modified elements.

20. The image processing apparatus of claim 18, wherein the randomly selected values comprise values related to a brightness of the image.
